(19) United States
(12) Patent Application Publication
(10) Pub. No.: US 2007/0276516 A1
(43) Pub. Date: Nov. 29, 2007

(54) Apparatus, method, system and software product for directing multiple devices to perform a complex task

(76) Inventors: Kari Kaarela, Oulu (FI); Elina Kaarela, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/441,385

(22) Filed: May 24, 2006

(51) Int. Cl. G05B 15/00

(52) U.S. Cl. 700/83

(57) ABSTRACT

An apparatus, method, and software product use a complex task signal that indicates a desired complex task which will be implemented by at least one electronic device, such as setting up a particular environment. In response to the complex task signal, a fetching application fetches a representation of a sequence of actions that will be taken by the electronic devices. An interpreter is configured to signal a control point layer in response to the representation, and, in response to that signal, a control point directs the sequence of actions to perform the complex task. This apparatus, method, and software can be implemented in a portable electronic apparatus, such as a mobile telephone, that is remote from the electronic devices.

### FIELD OF THE INVENTION

The present invention relates to connectivity and management of networked devices, and more particularly to sequences of actions for controlling networked devices to perform a complex task.

### BACKGROUND OF THE INVENTION

Technological innovation within several industries has been directed toward creating what is called the “digital home.” For example, there is a broad industry consortium called the Digital Living Network Alliance (DLNA) that has over 200 member companies including all the major consumer electronics (CE) players, information technology (IT) vendors, mobile phone companies, and the like. These companies share a vision of a digital home where all the devices are networked, and consumers can manage and enjoy their digitally stored content in a multitude of ways.

DLNA itself does not develop or define standards, but DLNA does publish what they call “Interoperability Guidelines,” which refer to a number of standards developed elsewhere. The idea is that products coming from various vendors—but developed according to these guidelines—should work seamlessly together.

Universal Plug and Play (UPNP) is one of the technical cornerstones of DLNA. UPNP technology defines an architecture for pervasive peer-to-peer network connectivity of intelligent appliances, wireless devices, and personal computers (PCs) of all form factors. UPNP is designed to bring easy-to-use, flexible, standards-based connectivity to ad hoc or unmanaged networks whether in the home, small business, public spaces, or attached to the Internet. UPNP technology provides a distributed, open networking architecture that leverages Transmission Control Protocol/Internet Protocol (TCP/IP) and Web technologies to enable seamless proximity networking in addition to control and data transfer among networked devices.

In the emerging digital home environment, users often share multimedia content with each other. As an example, homeowners may sit together with visitors, browse and search multimedia content stored in different home electronic devices (e.g. set-top boxes, PCs, and the like), and choose a movie to watch together. They typically use a portable device, such as a remote control or mobile phone, to browse or search for content, and the search result may be displayed on a large display (e.g., television) for everyone to see. In UPNP terminology, the devices that store content are called media servers, the devices that render the content are called media renderers, and the controlling devices that a user uses to search/browse content and control media servers and media renderers are called control points (CP). Further background information about control points can be found in the application of Wu et al., U.S. Patent Application No. 2006/0075015 (published 6 Apr. 2006), which is incorporated by reference herein.

UPNP technology makes sharing pictures, music, and videos over a home network easier, and UPNP technology is emerging as a technology of choice for controlling home security, lighting, heating/cooling, printers, and scanners. UPNP Device Control Protocols (DCPs) have now been released for a wide variety of device classes including Internet gateway devices, media servers, media renderers, printer devices, scanners, heating/ventilation/air-conditioning (HVAC), wireless local area network (WLAN) access point, device security, lighting controls, and remote user interface (UI) client and server.

The UPNP Device Architecture (UDA) is designed to support zero-configuration, “invisible” networking, and automatic discovery for a breadth of device categories from a wide range of vendors. This means a device can dynamically join a network, obtain an IP address, announce its name, convey its capabilities upon request, and learn about the presence and capabilities of other devices.

UPNP technology enables data communication between any two devices under the command of any control device on the network, and this technology is independent of any particular operating system, programming language, or physical medium. A device can leave a network smoothly and automatically without leaving any unwanted state information behind.

Although UPNP is applied widely for many types of devices, including printers, Internet gateway devices and routers, home automation, and so forth, an area of concentration for DLNA is audio/video (AV) devices and their interoperability. Consider a digital home where all the AV devices, lights, ventilation, heating and all kinds of electric appliances are networked and can be controlled remotely, for example via UPNP. UPNP is well-suited for use cases where only one or a limited number of devices need to be controlled in order to implement a use case scenario that the user wants. Examples of such use cases are, for instance, playing an mp3 song on a home stereo, or showing a video clip (stored in a telephone or in a home PC) on the living room television.

There are also use cases that require multiple devices or even multiple device categories to be switched on and controlled in order to implement a single use case scenario. A real-life example of such a use case scenario is the following: a person wants to watch a movie using his projector and his surround stereo system. In order to do that, he will have to switch on his projector, AV devices, home PC (if the movie is stored there), et cetera. He will also have to dim the lights, lower the shades (if it's light outside), and lower a white screen. Then, using his UPNP AV control point, he must select the movie, the rendering device, adjust the volume, select the picture ratio, select the audio input channel for the audio system, select the audio mode, et cetera. Whether or not a person is using UPNP, the above procedure to start watching a movie is anything but simple.

There is currently no known solution within UPNP/DLNA to solve the problem just described. UPNP technology is built on a device control protocol (DCP) philosophy, wherein for each UPNP device or category of UPNP devices, there is a DCP that defines how a specific control point (CP) can control a specific UPNP device and use its services.

### SUMMARY OF THE INVENTION

The present invention introduces a higher level of abstraction for the control of UPNP/DLNA devices and device categories that are required in order to implement a use case, for example when trying to start showing a movie with a projector or large screen TV having a connected high-quality audio system, light dimmer, and shades that need to be lowered. Such a higher level of abstraction comprises a number of statements according to a syntax capable of representing a sequence of UPNP actions. Extensible markup language (XML) and Simple Object Access Protocol (SOAP) are suitable for that purpose, and they are already used in UPNP.

The higher level of abstraction of UPNP actions to a number of UPNP devices can appear to the end-user, for example, as settings or environments, such as “home theatre”, “living room”, “bedroom”, and the like or as other “high-level” tasks such as “watch a movie.” In this case, the abstractions store information about devices that are used for a specific use case, and also store the actions that are required to enable a specific use case, such as watching a movie.

The present invention improves the usability of networked home devices by reducing the number of actions (e.g. key clicks) that are required in order to set up the devices and thus implement a complex use case scenario. The invention also enables the control of various UPNP device categories within a single structure, thus making it possible to implement more complex use case scenarios in a reasonably simple fashion. However, it is also possible to abstract a set of required UPNP actions for a single UPNP device in order to make its use simpler.

Accordingly, the usability of UPNP/DLNA devices in complex use case scenarios is substantially improved, instead of the user having to perform a set of UPNP actions to several devices. Repeating such actions every time one starts watching a movie, for example, in one's home theatre can be very irritating. Instead, according to the invention, the user may either program the sequence himself, or manually teach the sequence to the system by doing the sequence in a learn mode. Using the present invention, a user interface (UI) may be used to further enable ease-of-use by hiding the complexities from the end user.

The invention includes an apparatus, method, system, and software product that use a complex task signal which means a signal indicating a desired high-level task that will be implemented by at least one electronic device, to implement a complex use case scenario. This desired task may be indicated by a user via a user interface, and the complex task signal is then provided from the user interface to a fetching application. The fetching application then fetches a representation of a sequence of actions that will be taken by the electronic devices. An interpreter interprets the representation, and signals a control point layer in response thereto. The control point then directs the sequence of actions to perform the complex task.

### BRIEF DESCRIPTION OF THE DRAWINGS

FIG. 1 is a flow chart illustrating a method according to an embodiment of the present invention.

FIG. 2 is a block diagram illustrating an apparatus according to an embodiment of the present invention.

FIG. 3 shows a system according to an embodiment of the present invention, including the apparatus shown in FIG. 2.

### DETAILED DESCRIPTION

An embodiment of the present invention will now be detailed with the aid of the accompanying figures. It is to be understood that this embodiment is merely an illustration of one particular implementation of the invention, without in any way foreclosing other embodiments and implementations.

DCPs are normally defined at a low level, e.g. to control “tiny” actions provided by the services of the UPNP device in question. Using the DCPs, it is difficult to implement use case scenarios that would require the CP to automatically perform a sequence of actions without constant and direct user intervention. Even though the CP and device are logical entities, and it is possible to implement a single control point for a number of UPNP device categories, the situation becomes even more difficult when there are multiple device categories (e.g. UPNP AV, UPNP lighting, and the like) involved in the use case.

The present embodiment of the invention may be implemented using a UPNP stack (UDA) as well as a basic control point functionality that can be extended with the features required when adding new device control protocols (DCPs). In other words, the control point implementation has to be such that it can be extended to support several DCPs in order to control several UPNP device categories.

Implementation of this embodiment of the invention requires selection or definition of a language (i.e. grammar and vocabulary) that can represent sequences of UPNP actions dedicated to a set of UPNP devices. An existing XML or SOAP-based language may be suitable for this purpose, although the present invention is of course not limited to a particular language.

In this embodiment of the invention, an editor may be used to create and modify the above-mentioned representations. For usability reasons, it can also be advantageous to add a recorder (e.g. for learn mode), so that the user can manually control the multiple devices and/or device categories so as to perform the desired sequence of actions while the system learns the required sequence (e.g. to prepare the home theatre for watching a movie). Instead of being learned, the sequence of actions may also be pre-installed in the Control Point, or the sequence may be downloadable.

Implementation of the present embodiment of the invention furthermore requires a parser and/or command scheduler that can interpret the above-mentioned representations, and pass actions and arguments to a generic control point layer. The generic control point will be capable of handling a selected set of DCPs, for using the services of certain UPNP device categories.

Additionally, implementation of this embodiment of the invention also may include a user interface (UI) and application logic extensions, in order to take care of tasks such as storing and fetching the above-mentioned representations. The devices should preferably be such that they could be in a sleep mode and be awakened upon request from the control point.

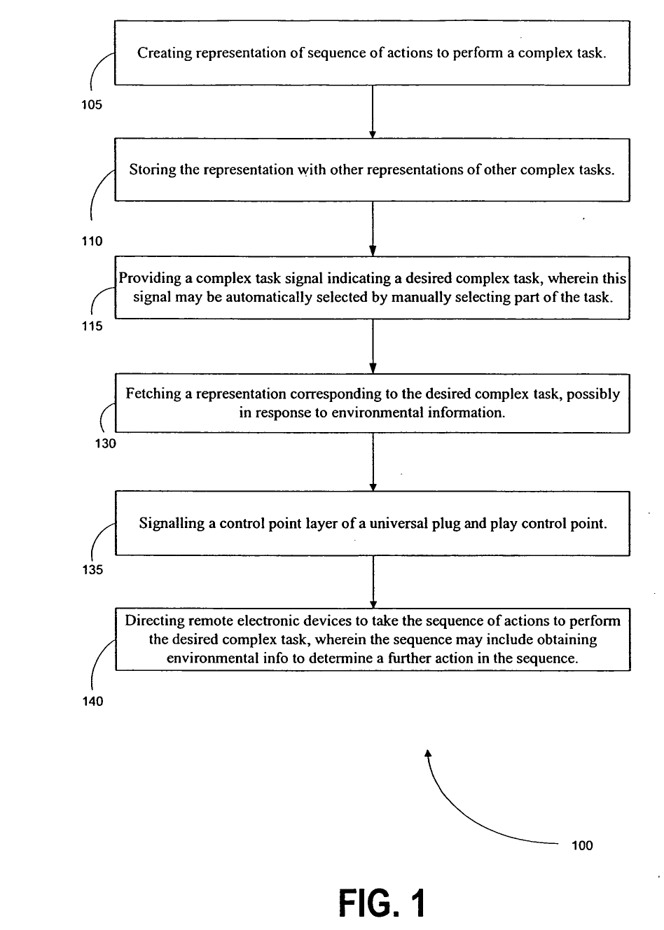

Referring now to the figures, FIG. 1 is a flow chart of a method 100 which begins with creating 105 a representation of actions needed to perform a complex task, such as a sequence of actions necessary to create an environment. The representation is then stored 110 in a memory, along with other representations of various other respective representations needed to create other respective complex tasks. Eventually, a complex task signal is provided 115 indicating a desired complex task. This signal can be in response to direct manual user input, or in response to a timer, or in response to a remote user command (e.g. a telephone call from the user).

In any event, a representation is then fetched 130 from the memory, corresponding to the desired complex task. When the representation has been obtained, a control point layer is signalled 135, the control point being a UPNP control point. Finally, the control point directs 140 remote electronic devices to take the sequence of actions needed to perform the complex task (e.g. to create the desired environment).

The sequence of actions needed to perform a complex task could be based on the outcome of the previous action(s). For example, the sharpness of the TV could be based on the previous light dimming, or the sound of the movie could be based on the background noise. The complex task definition could include non-UPnP actions and/or UPNP actions, in order to obtain information about the environment (such as the “light level” that could be obtained from a camera), and conditional statements using that kind of environment. Based on the conditional statements, the high-level task sequence could then have several branches (as in typical programming). In this scenario, the high-level sequence itself could include “input” statements to get external information, and conditional branch statements to control the flow of actions to be suited for various conditions such as environmental conditions.

Accordingly, the sequence of actions may include obtaining environmental information after performing at least one of the actions, in order to determine at least one further action. Similarly, the fetching 130 may fetch the representation at least partly in response to environmental information.

Note that many word processing programs automatically finish typing a word once the user has begun to type it, and this principle can be extended to performing a complex task. Thus, the complex task signal could be provided 115 by selecting a portion of the complex task, or at least partly in response to selecting a portion of the complex task.

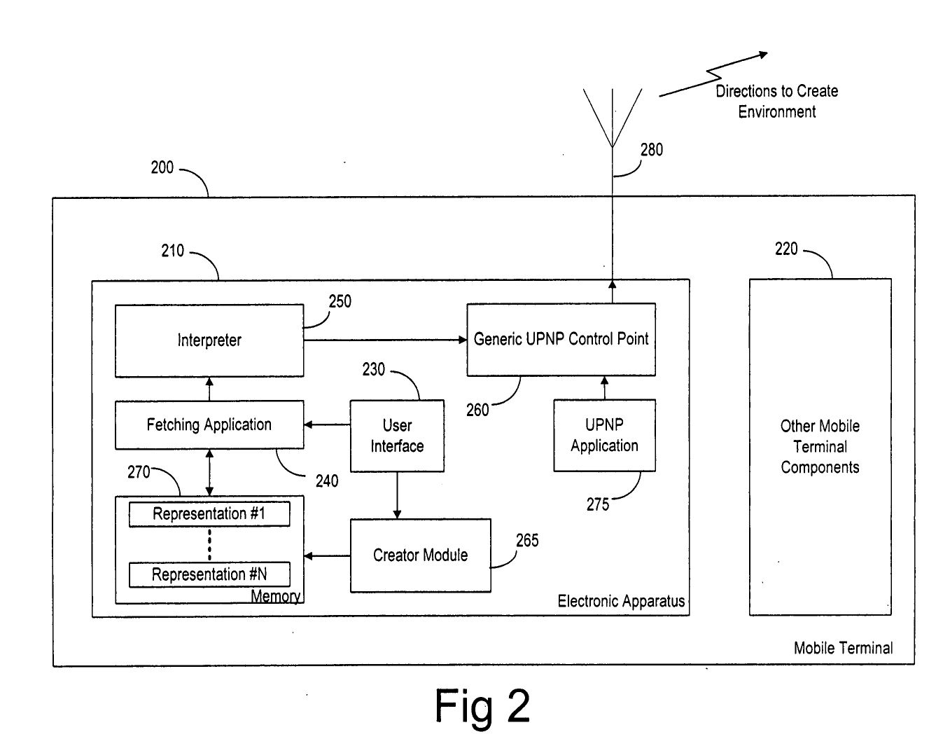

Turning now to FIG. 2, an electronic apparatus 210 according to the present invention is housed within a mobile terminal 200. Of course, other portable devices could house the apparatus, instead of a mobile telephone. In case of a mobile terminal, various other mobile terminal components 220 are needed, but need not be further detailed herein. The apparatus 210 includes a user interface 230, by which the user indicates to a fetching application 240 what complex task is desired. The fetching application then retrieves a corresponding representation from the memory 270, and provides the representation to an interpreter 250 which can be a parser or a command scheduler. The interpreter then provides a signal including actions and/or arguments to a generic control point layer 260, which in turn sends directions for performing the complex task, via antenna 280, and the directions may utilize a UPNP application 275.

The interpreter 250 parses the XML or SOAP presentation of the high-level task scenario in question in order to find the sequence (together with possible timing info) of separate UPNP actions, and to identify the device to which each of the actions should be sent. It is also the task of the interpreter, based on the acknowledgement messages from the devices, to ensure that the sequence is progressing as planned. In an error case, the user should be informed.

The representation can be created in the first place as follows. The user uses the user interface 230 to design the representation by sending various programming commands to a creator module 265, and the creator module then send the representation to the memory 270. Alternatively, the user can use the user interface 230 to directly send directions to each of the electronic devices one-by-one, as the creator module 265 (operating in a learn mode) records what the user is doing. Again, this enables the creator module 265 to construct a representation, which is then sent to the memory 270.

The learn mode works in some ways as the opposite of the interpreter 250. The learn mode, when activated, records the sequence of user-initiated UPnP actions to control the plurality of devices needed to implement the intended high-level use case scenario. When the user indicates that the learn mode has been completed, the sequence of UPNP actions (per device), together with the timing information, is stored in the selected XML or SOAP format to the device's memory.

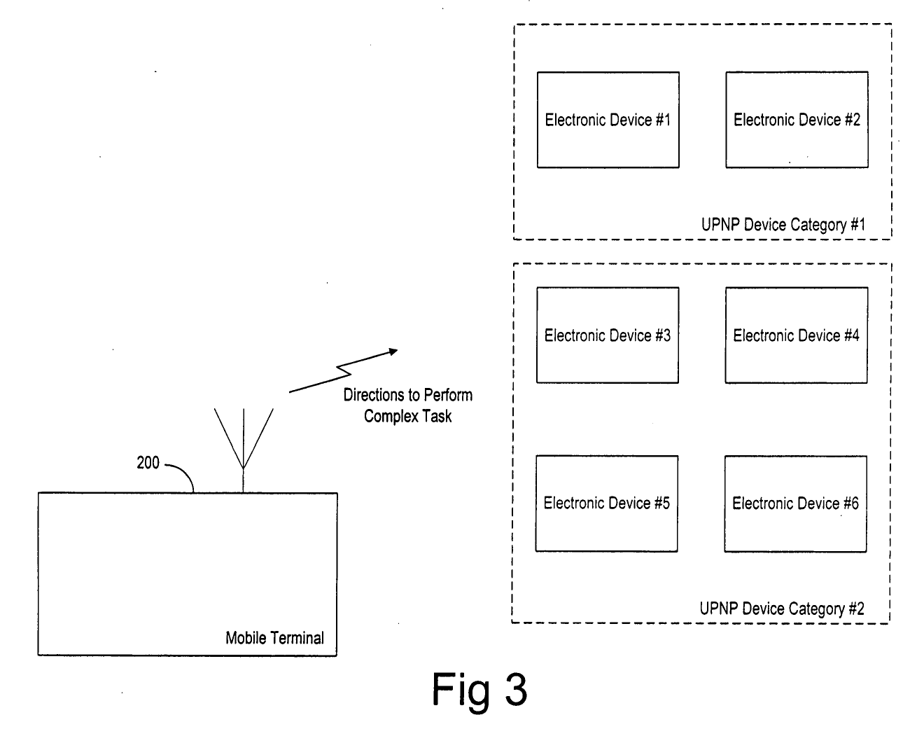

FIG. 3 again shows the mobile terminal 200, interacting with the rest of the system, including various electronic devices. In this example, electronic devices #1 and #2 are in a first UPNP device category, and the remaining electronic devices are in a second UPNP device category. All of these devices can be told what to do in response to the user merely indicating what complex task the user desires (e.g. which environment the user would like created).

Of course, the present invention also includes a software product for performing the embodiment of the method described above, and the software can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a CPU processor comprising a single processing unit, multiple processing units capable of parallel operation, or the CPU can be distributed across one or more processing units in one or more locations, e.g., on a client and server, or within components 220 as shown in FIG. 2. Memory 270 may comprise any known type of data storage and/or transmission media, including magnetic media, optical media, random access memory (RAM), read-only memory (ROM), a data cache, a data object, or the like. Moreover, similarly to the CPU, memory 270 may reside at a single physical location, comprising one or more types of data storage, or be distributed across a plurality of physical systems in various forms.

It is to be understood that all of the present figures, and the accompanying narrative discussions of corresponding embodiments, do not purport to be completely rigorous treatments of the method, apparatus, system, and software product under consideration. A person skilled in the art will understand that the steps and signals of the present application represent general cause-and-effect relationships that do not exclude intermediate interactions of various types, and will further understand that the various steps and structures described in this application can be implemented by a various steps and structures described in this application can be implemented by a variety of different sequences and configurations, using various combinations of hardware and software which need not be further detailed herein. Likewise, although the claims listed below contain dependent claims having specific dependencies, it is to be understood that the scope of the invention encompasses all possible combinations of claim dependencies.

What is claimed is:

1. An apparatus comprising:
a user interface configured to provide a complex task signal indicative of a desired complex task that is to be implemented by at least one electronic device;
a fetching application configured to fetch a representation of a sequence of actions by the at least one electronic device, in response to the complex task signal;
an interpreter configured to signal a control point layer in response to the representation; and
a control point configured to direct the sequence of actions to perform the complex task, in response to the signal from the interpreter.

2. The apparatus of claim 1, further comprising:
a creator module configured to create the representation in response to programming commands, or in response to performing the sequence in a learn mode,
wherein the creator module is also configured to send the representation to a memory, for eventual retrieval in response to the complex task signal.

3. The apparatus of claim 1,
wherein the control point is a universal plug and play control point supporting at least one universal plug and play device control protocol (DCP);
wherein the apparatus is remote from the at least one electronic device; and
wherein the at least one electronic device are within at least two respective universal plug and play device categories.

4. The apparatus of claim 2,
wherein the apparatus is part of a mobile telephone; and
wherein the memory includes at least one other representation corresponding to at least one other complex task.

5. The apparatus of claim 1,
wherein the sequence of actions includes obtaining environmental information after performing at least one of the actions in order to determine at least one further action.

6. The apparatus of claim 1,
wherein the fetching application is also configured to fetch the representation at least partly in response to environmental information.

7. The apparatus of claim 1,
wherein the complex task signal is selected at least partly in response to selecting a portion of the complex task.

8. The apparatus of claim 1,
wherein the interpreter is also configured to interpret the representation before signalling the control point layer;
wherein the signalling includes passing actions or arguments to the control point layer; and
wherein the control point and the control point layer are generic and configured for handling a selected set of device control protocols.

9. An apparatus comprising:
means for providing a complex task signal indicative of a desired complex task that is to be implemented by at least one electronic device;
means for fetching a representation of a sequence of actions by the at least one electronic device, in response to the complex task signal;
means for signalling a control point layer in response to the representation; and
means for directing the sequence of actions to perform the complex task, in response to the signal from the interpreter.

10. The apparatus of claim 9, further comprising:
means for creating the representation in response to programming commands, or in response to performing the sequence in a learn mode,
wherein the creating means is also configured to send the representation to memory means, for eventual retrieval in response to the complex task signal.

11. A method comprising:
providing a complex task signal indicative of a desired complex task that is to be implemented by at least one electronic device;
fetching a representation of a sequence of actions by the at least one electronic device, in response to the complex task signal;
signalling a control point layer in response to the representation; and
directing the sequence of actions to perform the complex task, in response to the signalling.

12. The method of claim 11,
wherein the providing, the fetching, the signalling, and the directing are performed within an apparatus having the control point;
wherein the control point is a universal plug and play control point;
wherein the apparatus is remote from the at least one electronic device; and
wherein the at least one electronic device are within at least two respective universal plug and play device categories.

13. The method of claim 12,
wherein the apparatus is part of a mobile telephone;
wherein the representation is stored in a memory of the mobile telephone; and
wherein the memory includes at least one other representation corresponding to at least one other complex task.

14. The method of claim 13, preceded by the steps of:
creating the representation in response to programming commands, or in response to performing the sequence in a learn mode; and
storing the representation in the memory for retrieval in response to the complex task.

15. The method of claim 11,
wherein the signalling is performed after interpreting the representation;
wherein the signalling includes passing actions or arguments to the control point layer; and
wherein the control point and the control point layer are generic and configured for handling a selected set of device control protocols.

16. The method of claim 11,
wherein the sequence of actions includes obtaining environmental information after performing at least one of the actions in order to determine at least one further action.

17. The method of claim 11,
wherein the fetching fetches the representation at least partly in response to environmental information.

18. The method of claim 11,
wherein the complex task signal is selected at least partly in response to selecting a portion of the complex task.

19. A computer readable medium encoded with a software data structure for performing the method of claim 11.

20. A software product comprising a computer readable medium having executable codes embedded therein, the codes when executed being sufficient to carry out the functions of:
providing a complex task signal indicative of a desired complex task that is to be implemented by at least one electronic device;
fetching a representation of a sequence of actions by the at least one electronic device, in response to the complex task signal;
signalling a control point layer in response to the representation; and
directing the sequence of actions to perform the complex task, in response to the signalling.

21. The software product of claim 20,
wherein the providing, the fetching, the signalling, and the directing are carried out within an apparatus having the control point;
wherein the control point is a universal plug and play control point;
wherein the apparatus is remote from the at least one electronic device; and
wherein the at least one electronic device are within at least two respective universal plug and play device categories.

22. The software product of claim 20,
wherein the signalling is performed after interpreting the representation;
wherein the signalling includes passing actions or arguments to the control point layer; and
wherein the control point and the control point layer are generic and configured for handling a selected set of device control protocols.
